(19) United States
(12) Patent Application Publication
(10) Pub. No.: US 2005/0115831 A1
(43) Pub. Date: Jun. 2, 2005

(54) Eletrochemical sensing device

(75) Inventor: Chun-Mu Huang, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: BioNime Corporation, Taichung County (TW)

(21) Appl. No.: 10/981,250

(22) Filed: Nov. 4, 2004

(30) Foreign Application Priority Data
Nov. 5, 2003 (TW) 092131009

(51) Int. Cl. G01N 27/26

(52) U.S. Cl. 204/403.02; 204/403.03

(57) ABSTRACT

An electrochemical sensing device is provided. The electrochemical sensing device includes a main body having a connecting slot, a testing holder having a detachable connection to the connecting slot and having a storage component, and an electrochemical sensing strip detachably combined with the testing holder for analyzing a sample.

### FIELD OF THE INVENTION

The present invention relates to an electrochemical sensing device, and more particular to an electrochemical sensor having a detachable testing holder.

### BACKGROUND OF THE INVENTION

In recent decades, the principle of electrochemical sensing has been developed and applied in the field of detecting kinds of fluid ingredients. An electrochemical sensing device may be assembled with different equipments in different application fields. Nevertheless, an electrochemical sensing device in a general laboratory is generally different from that in a professional checking room. A basic framework of an electrochemical sensing device includes the following components:

1. A container, which is applied to contain a fluid sample and is a region for measuring an electrochemical reaction;

2. A chemical reagent, which is used for chemically reacting with an analyte contained in the fluid sample and generating an output signal with an electric parameter accordingly, wherein the electric parameter is corresponding to an ingredient of the analyte contained in the fluid sample;

3. Plural testing electrodes, which are selected from a group consisting of a counter electrode, a working electrode, a reference electrode, and a detecting electrode; and

4. A measuring device, such as an electrochemical meter, which provides the essential working voltage (or current) needed by the electrochemical reaction and measures the electric parameter (output voltage or current) produced by the electrochemical reaction to be recorded for processing the numerical analysis and displaying the testing result thereon.

In recent years, the electrochemical sensing device including a disposable electrochemical sensing strip and a main testing body is widely used for measuring an electrochemical reaction and the strength thereof. In general, the disposable sensing strip includes a reaction concavity, an electrochemical reaction layer, some electrode devices and so on. The main testing body provides the essential working voltage (or current) needed by the electrochemical reaction and measures the electric parameter (output voltage or current) produced by the electrochemical reaction to be recorded for processing the numerical analysis and displaying the testing result thereon. Nowadays, most of the health measuring devices, such as blood glucose meter, the uric acid meter, and the cholesterol meter, are the electrochemical sensing devices used in daily life.

Since the raw materials and the detailed manufacturing environments for the different batches of the electrochemical sensing strips still cannot be controlled very well at present, identical reactions between each electrochemical sensing strip and the target analyte can not be obtained. However, since the electrochemical sensing strips within the same batch are made of the same raw materials under the extremely similar manufacturing environments, their reactivities to a target analyte would be almost the same. Therefore, some electrochemical sensing strips within the same batch would be taken as samples for testing the relationship between the electrochemical sensing strips and the target analyte, and the testing results would be programmed into a program and the program would be stored in a storage device for being the correcting foundation during the practical applications. During the practical application, the storage device would be installed into a testing device first for correcting the testing device according to the program, and then the electrochemical sensing strip corresponding to the program is installed into the testing device for analyzing a sample.

As above-mentioned, it should have been noted that once the electrochemical sensing strips in the batch regarding the program in the storage device are exhausted, the storage device would become useless and should be renewed.

Please refer to FIG. 1, which shows the schematic view of the electrochemical sensing device according to the prior art. As shown in FIG. 1, the electrochemical sensing device 1 includes the testing body 11, the storage device 12 having the storage chip 121, and the electrochemical sensing strip 13. The testing body 11 includes the connecting slots 111 and 112 for respectively connecting with the storage device 12 and the electrochemical sensing strip 13. The storage chip 121 includes the information about the correction information of the electrochemical sensing strip 13. In addition to holding the electrochemical sensing strip 13, the connecting slot 112 also receives the signals of the electrochemical sensing strip 13 via the electrodes 1121. Nevertheless, in general, the testing result of an electrochemical reaction is determined by the measuring time, that is to say that the testing results of different measuring time for the same reaction would be different. Therefore, the normal representative result for an electrochemical reaction is generally defined as the testing result obtained immediately after the happening of the reaction, nowadays. For example, taking the current blood glucose meter as an example, in order to obtain the testing result as soon as possible, the electrochemical sensing strip 13 is installed into the connecting slot 112 first, and then the user drops some blood onto the electrochemical sensing strip for being analyzed. However, some parts of the blood glucose meter are easily contaminated during the dropping process since it is difficult to completely control the quantity of the blood and some users have their own personal problems, such as vision problems and the equilibrant problems. In addition, the contamination not only causes some testing errors, affects the appearance of the meter, but also endangers the users (since the contamination might be infectious). In addition, since the connecting devices of the conventional electrochemical sensing device (such as the connecting slots and the relevant connecting components, for example, the metal strips) are always parts of the electrochemical sensing device and cannot be replaced by the user, it is always necessary to replace the whole electrochemical sensing device when the connecting devices are defected due to that the elasticity of the relevant connecting component is decreased and the poor contact resulting from being used for hundred times of strip insertions. In fact, almost the operating life of the conventional electrochemical sensing device is dependent on the operating life of the connecting slot for the sensing strip.

Furthermore, since the current electrochemical sensing strip is usually disposable, the electrochemical sensing device always has two connecting slots, one is used for connecting with the storage device and the other is used for connecting with the electrochemical sensing strip. Nevertheless, in order to simplify the structure of the electrochemical sensing device, reduce the occurrence of the relevant contamination, and lower down the relevant cost, it is necessary to rearrange the components of the electrochemical sensing device.

According to the drawbacks described above, for reducing the structural complexity of the electrochemical sensing device and the operating-life problems of sensing device dependent on the connecting slot for the sensing strip and the relevant cost, the applicant has devoted himself to develop a new electrochemical sensing device with a detachable testing holder through a series of experiments, tests and researches.

### SUMMARY OF THE INVENTION

In accordance with an aspect of the present invention, an electrochemical sensing device is provided. The electrochemical sensing device includes a main body having a connecting slot, a testing holder having a detachable connection to the connecting slot, and an electrochemical sensing strip detachably combined with the testing holder for analyzing a sample.

Preferably, the main body further includes a display and a control key.

Preferably, the testing holder is a disposable testing holder.

Preferably, the testing holder further includes a storage component storing a correction information.

Preferably, the connecting slot further includes a plurality of signal contacts.

Preferably, the correction information is transmitted to the main body via the plurality of signal contacts when the testing holder is combined with the connecting slot.

Preferably, the electrochemical sensing strip includes at least an insulating substrate having a reaction concavity and an opening located thereon, an electrochemical reaction layer located in the reaction concavity, and an electrode device located in the reaction concavity for transmitting a signal resulting from an electrochemical reaction performed in the electrochemical reaction layer.

Preferably, the reaction concavity includes at least a hole.

Preferably, the electrode device passes through the hole.

Preferably, the electrode device includes plural electrodes selected from a group consisting of a counter electrode, a working electrode, a reference electrode and a detecting electrode.

Preferably, the plural electrodes are connected to the signal contacts for transmitting the signal when the testing holder is combined with the connecting slot and the electrochemical sensing strip is combined with the testing holder.

Preferably, each of the plural electrodes includes a metal and a thin film.

Preferably, the metal is one selected from a group consisting of a copper, a titanium, a nickel, a gold, a platinum, a rhodium, a palladium, a ruthenium, a silver, a chromium, an iron, an aluminum, an iridium and an alloy thereof.

Preferably, the thin film is made of a material selected from a group consisting of a copper, a titanium, a nickel, a gold, a platinum, a rhodium, a palladium, a ruthenium, a silver, a chromium, an iron, an aluminum, an iridium and an alloy thereof.

Preferably, each of the plural electrodes includes a carbon body and a thin film.

Preferably, the electrochemical reaction layer further includes a chemical agent for reacting with an analyte of the sample to generate the signal.

Preferably, the sample is added into the reaction concavity via said opening.

In accordance with another aspect of the present application, an electrochemical sensor is also provided. The electrochemical sensor includes a main body having a detachable testing device, and an electrochemical sensing strip detachably combined with the detachable testing holder for analyzing a sample.

Preferably, the detachable testing device includes a base having plural signal contacts and a disposable testing holder.

Preferably, the detachable testing device is connected to a storage component storing a correction information.

Preferably, the correction information is transmitted to the main body via the plural signal contacts when the detachable testing device is combined with the main body.

Preferably, the electrochemical sensing strip includes at least an insulating substrate having a reaction concavity and an opening located thereon, an electrochemical reaction layer located in the reaction concavity, and an electrode device located in the reaction concavity for transmitting a signal resulting from an electrochemical reaction performed in the electrochemical reaction layer.

Preferably, the reaction concavity includes at least a hole.

Preferably, the electrode device passes through the hole.

Preferably, the electrode device includes plural electrodes selected from a group consisting of a counter electrode, a working electrode, a reference electrode and a detecting electrode.

Preferably, the plural electrodes are connected to the signal contacts for transmitting the signal when the detachable testing device is combined with the connecting slot and the electrochemical sensing strip is combined with the main body.

Preferably, each of the plural electrodes includes a metal and a thin film.

Preferably, the thin film is made of a material selected from a group consisting of a copper, a titanium, a nickel, a gold, a platinum, a rhodium, a palladium, a ruthenium, a silver, a chromium, an iron, an aluminum, an iridium and an alloy thereof.

Preferably, each of the plural electrodes includes a carbon body and a thin film.

Preferably, the electrochemical reaction layer further includes a chemical agent for reacting with an analyte of the sample to generate said signal.

Preferably, the sample is added into the reaction concavity via the opening.

In accordance with another aspect of the present application, a portable electrochemical sensing device is provided. The portable electrochemical sensing device includes a main body having a connecting slot, and a testing holder having a detachable connection to the connecting slot.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic view of the electrochemical sensing device in the prior art;

FIG. 2(A) is the exploded view of the disposable electrochemical sensing strip according to the first embodiment of the present invention;

FIG. 2(B) is the perspective view showing the electrochemical sensing strip according to the first embodiment of the present invention;

FIG. 2(C) is the schematic view showing the appearance of the electrochemical sensing strip according to the first embodiment of the present invention;

FIG. 2(D) is the back view of the disposable electrochemical sensing strip according to the first embodiment of the present invention;

FIG. 3(A) is the exploded view of the disposable electrochemical sensing strip according to the second embodiment of the present invention;

FIG. 3(B) is the perspective view showing the electrochemical sensing strip according to the second embodiment of the present invention;

FIG. 3(C) is the back view of the disposable electrochemical sensing strip according to the second embodiment of the present invention;

FIG. 4(A) is the schematic view showing the components of the electrochemical sensing device according to the first embodiment of the present invention;

FIG. 4(B) is the schematic view showing the assembly of the components shown in FIG. 4(A);

FIG. 5(A) is the schematic view showing the components of the electrochemical sensing device according to the second embodiment of the present invention;

FIG. 5(B) is the back view showing the components of the electrochemical sensing device according to the second embodiment of the present invention;

FIG. 5(C) is the schematic view showing the assembly of the components shown in FIG. 5(A); and

FIG. 5(D) is the back view showing the assembly of the components shown in FIG. 5(A).

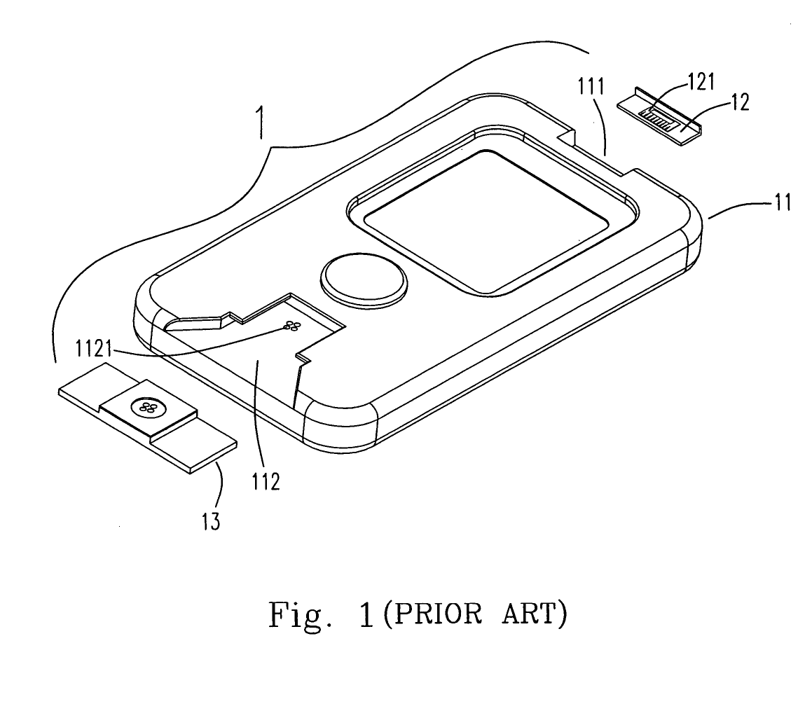

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

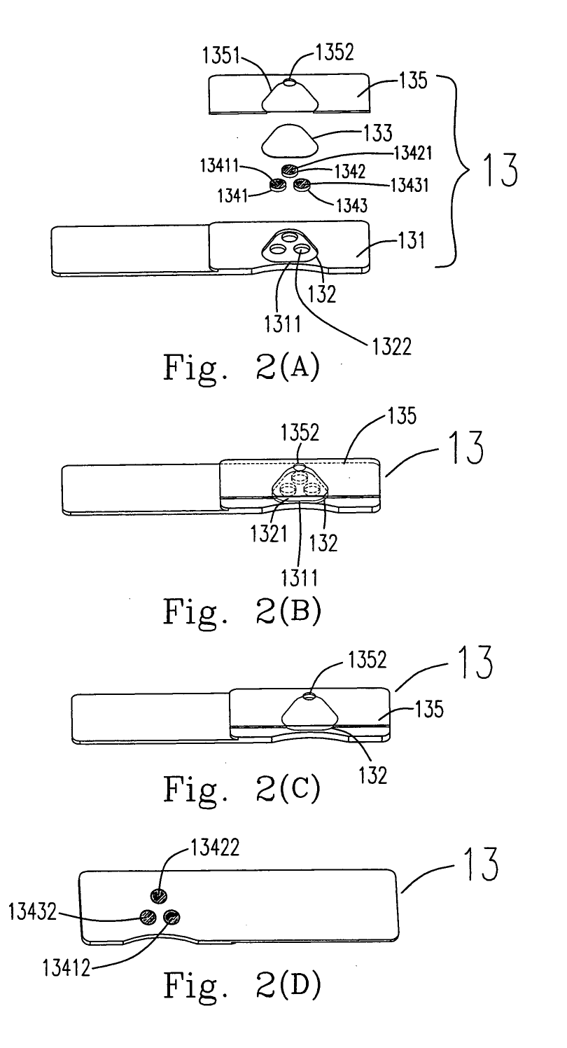

Please refer to FIGS. 2(A)-2(D), wherein FIG. 2(A) is the exploded view of the disposable electrochemical sensing strip according to the first embodiment of the present invention, FIG. 2(B) is the perspective view showing the electrochemical sensing strip according to the embodiment, FIG. 2(C) is the schematic view showing the appearance of the electrochemical sensing strip according to the first embodiment, and FIG. 2(D) is the back view of the disposable electrochemical sensing strip according to the embodiment. As shown in FIG. 2(A), the electrochemical sensing strip 13 includes the insulating substrate 131 with the reaction concavity 132 located thereon and the side 1311 located between the reaction concavity 132 and an edge of the insulating substrate 131, the electrochemical reaction layer 133 located in the reaction concavity 132 for performing an electrochemical reaction, the cover 135 with the window 1351 and the ventilator 1352, the opening 1321 and the plural electrodes 1341, 1342, and 1343. The plural electrodes 1341, 1342, and 1343 respectively have two metal thin films on their end surfaces, which are the metal thin films 13411, 13412, 13421, 13422, 13431 and 13432, for detecting and transmitting the signal resulting from the electrochemical reaction. In addition, there are plural holes 1322 located at the bottom of the reaction concavity 132, and the plural electrodes 1341, 1342, and 1343 respectively pass through the holes 1322. Since the electrochemical sensing strip 13 has the side 1311, the opening 1321 and the ventilator 1352, a capillary channel will be formed in the zone between the opening 1321 and the ventilator 1352. When a sample (not shown) enters the reaction concavity 132 through the opening 1321, the sample will be able to be spread uniformly into the reaction concavity 132 due to the siphon phenomenon on the capillary channel, and then an electrochemical reaction will be performed between the sample and the chemical compositions contained in the electrochemical reaction layer 133. During the electrochemical reaction, the ventilator 1352 is applied to exhaust the redundant air in the reaction concavity 132 so as to maintain the pressure balance between the inner air of the reaction concavity 132 and the outer air thereof. There is a transparent membrane mounted in the window 1351 for observing the movement of the sample and the electrochemical reaction in the reaction concavity 132. The plural electrodes 1341, 1342, and 1343 are the counter electrode 1341, the working electrode 1342, and the reference electrode 1343. In addition, another electrode (such as a detecting electrode) is able to be installed in the electrochemical sensing strip 13, if necessary. Furthermore, it should be noted that the electrochemical sensing strip 13 is able to work as long as it includes a counter electrode and a working electrode, or a reference electrode and a working electrode.

Nowadays, in general, the electrodes 1341, 1342, 1343 and the metal thin films 13411, 13412, 13421, 13422, 13431 and 13432 are made of one material selected from a group consisting of a copper, a titanium, a nickel, a gold, a platinum, a rhodium, a palladium, a ruthenium, a silver, a chromium, an iron, an aluminum, an iridium and an alloy thereof. In which, a brass, an oxygen-free copper, a bronze, a phosphorized copper, a nickel silver copper and a beryllium copper are the most commonly used materials. Because the end surfaces of the electrodes should have the high sensitivity and stability, and the requirements of the sensitivity and the stability of the other portions of the electrodes are not so strict, only the end surfaces of the electrodes are necessarily formed by the noble metal and the other portions could be formed by general metals or the carbon for reducing the relevant cost. In addition, since the insulating substrate 131 and the reaction concavity 132 are formed integrally by the plastic injection molding, the relevant costs are reduced.

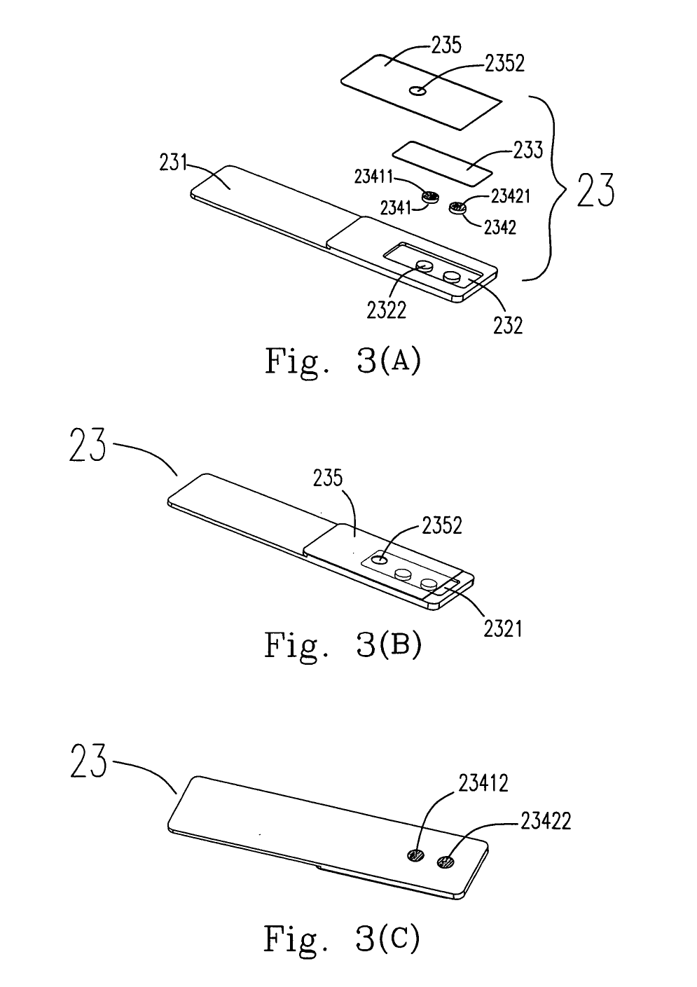

Please refer to FIGS. 3(A)-3(B), which are schematic views showing the electrochemical sensing strip according to the second embodiment of the present invention. FIG. 3(A) is the exploded view of the electrochemical sensing strip according to the second embodiment of the present invention, FIG. 3(B) is the schematic view showing the appearance of the electrochemical sensing strip according to the second embodiment, and FIG. 3(C) is the back view of the disposable electrochemical sensing strip according to the embodiment. As shown in FIG. 3(A), the electrochemical sensing strip 23 includes the insulating substrate 231 with the reaction concavity 232 located thereon, the electrochemical reaction layer 233 located in the reaction concavity 232 for performing an electrochemical reaction, the cover 235 with the window 2351 and the ventilator 2352, the opening 2321 and the plural electrodes 2341 and 2342. The plural electrodes 2341 and 2342 respectively have two metal thin films on their end surfaces, which are the metal thin films 23411, 23412, 23421 and 23422 for detecting and transmitting the signal resulting from the electrochemical reaction. In addition, there are plural holes 2322 located at the bottom of the reaction concavity 232, and the plural electrodes 2341 and 2342 respectively pass through the holes 2322. Since the electrochemical sensing strip 23 has the opening 2321 and the ventilator 2352, a capillary channel will be formed in the zone between the opening 2321 and the ventilator 2352. When a sample (not shown) enters the reaction concavity 232 through the opening 2321, the sample will be able to be spread uniformly into the reaction concavity 232 due to the siphon phenomenon on the capillary channel, and then an electrochemical reaction will be performed between the sample and the chemical compositions contained in the electrochemical reaction layer 233. During the electrochemical reaction, the ventilator 2352 is applied to exhaust the redundant air in the reaction concavity 232 so as to maintain the pressure balance between the inner air of the reaction concavity 232 and the outer air thereof. There is a transparent membrane mounted in the window 2351 for observing the movement of the sample and the electrochemical reaction in the reaction concavity 232. The plural electrodes 2341, 2342, and 2343 are the counter electrode 2341 and the working electrode 1342. In addition, the counter electrode 2341 is able to be replaced by an reference electrode and another electrode (such as a detecting electrode) is able to be installed in the electrochemical sensing strip 23, if necessary.

Nowadays, in general, the electrodes 2341, 2342 and the metal thin films 23411, 23412, 23421 and 23422 are made of one material selected from a group consisting of a copper, a titanium, a nickel, a gold, a platinum, a rhodium, a palladium, a ruthenium, a silver, a chromium, an iron, an aluminum, an iridium and an alloy thereof. In which, a brass, an oxygen-free copper, a bronze, a phosphorized copper, a nickel silver copper and a beryllium copper are the most commonly used materials. Because the end surfaces of the electrodes should have the high sensitivity and stability, and the requirements of the sensitivity and the stability of the other portions of the electrodes are not so strict, only the end surfaces of the electrodes are necessarily formed by the noble metal and the other portions could be formed by general metals or the carbon for reducing the relevant cost. In addition, since the insulating substrate 231 and the reaction concavity 232 are formed integrally by the plastic injection molding, the relevant costs are reduced.

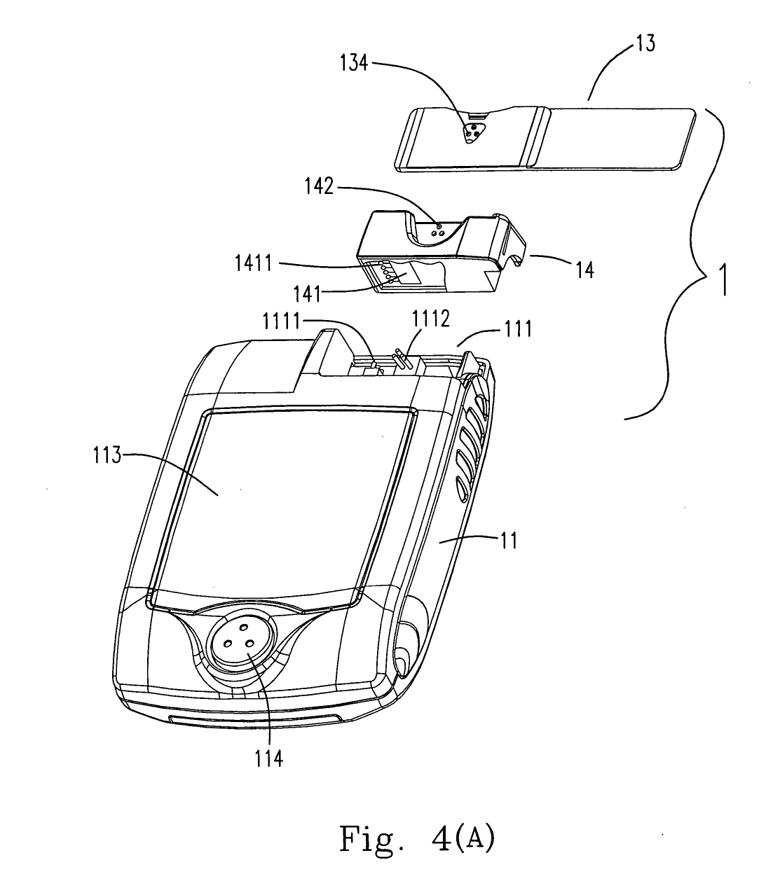

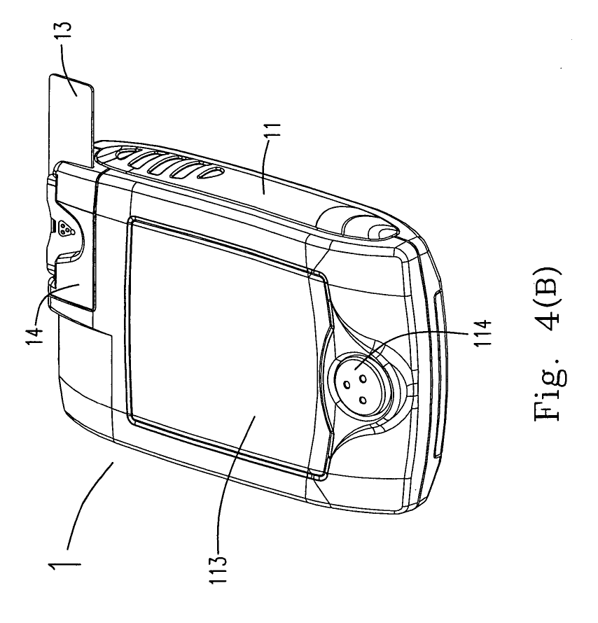

Please refer to FIGS. 4(A)-4(B). FIG. 4(A) is the schematic view showing the components of the electrochemical sensing device according to the first embodiment of the present invention, and FIG. 4(B) is the schematic view showing the assembly of the components shown in FIG. 4(A). As shown in FIG. 4(A), the electrochemical sensing device 1 includes the testing body 11, the electrochemical sensing strip 13, the display 113, and the control key 114. The testing body 11 includes the connecting slot 111, a testing holder 14 detachably connected to the connecting slot 111, a storage component 141, and the signal contacts 1411. The electrochemical sensing strip 13 includes the electrodes 134 and is able to be connected to the testing holder 14. In which, the testing holder 14 includes plural connecting holes 142.

As shown in FIGS. 4(A)-(B), since the reactions between the electrochemical sensing strip within different batches and the target analyte are not exactly identical, it is necessary to find out the correction information for the individual batch of electrochemical sensing strips. However, the correction information is what stored in the storage component 141. During the practical application, the stored correction information in the storage component 141 would be transmitted to the testing body 11 via the signal contact 1111 on the connecting slot 111 when the testing holder 14 is connected to the connecting slot 111. Since the testing holder 14 has a detachable connection to the connecting slot 111 and is specific to the electrochemical sensing strips 13 within the particular batch, the testing holder 14 would become useless and should be exchanged when the electrochemical sensing strips 13 within the relevant batch are used out. In addition, the signal contacts 1112 would be connected to the electrodes 134 via the connecting holes 142 for transmitting the signal resulting from the electrochemical reaction into the testing body 11 when the electrochemical sensing strip 13 is connected to the testing holder 14 and the testing holder 14 is connected to the connecting slot 111.

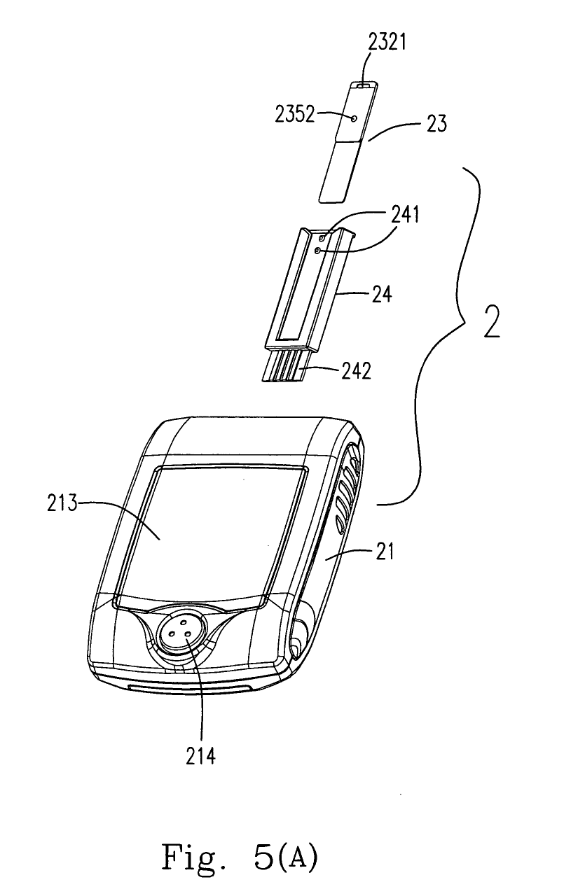

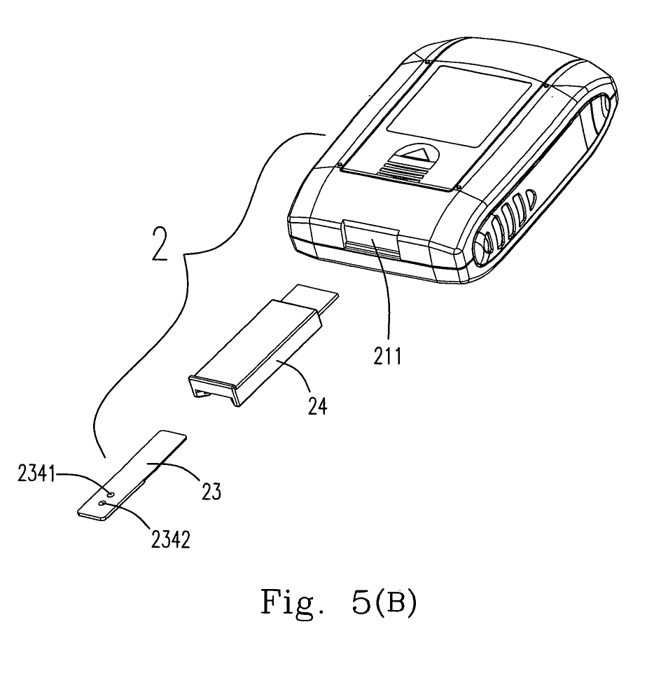

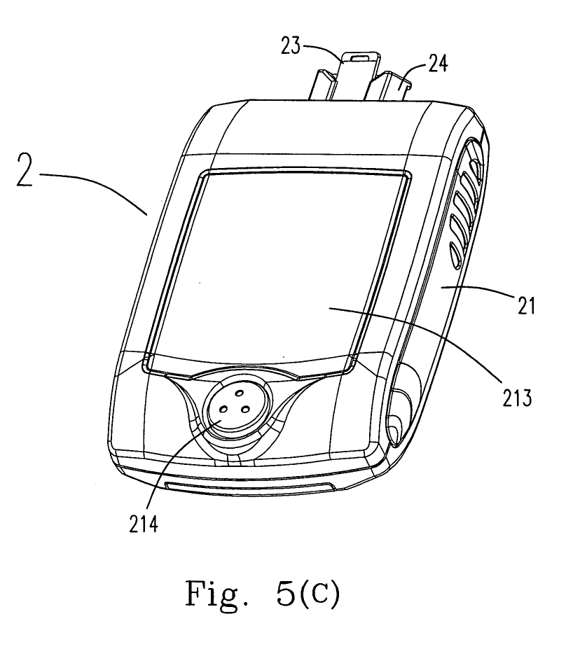

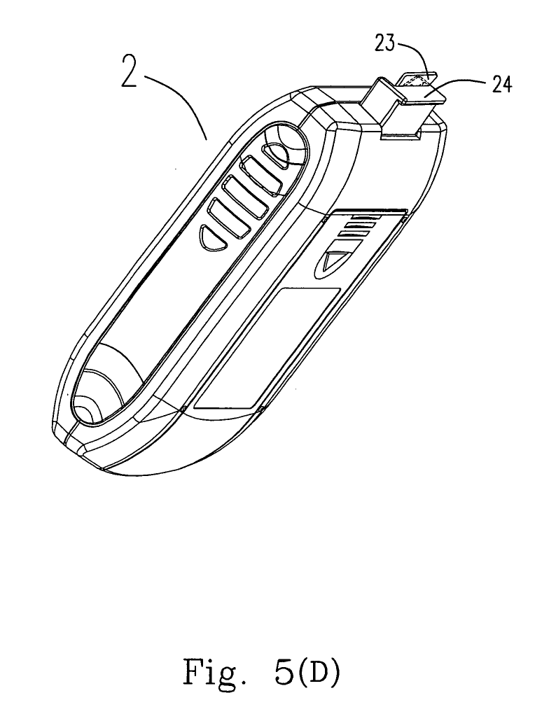

Please refer to FIGS. 5(A)-5(D). FIG. 5(A) is the schematic view showing the components of the electrochemical sensing device according to the second embodiment of the present invention, FIG. 5(B) is the back view showing the components of the electrochemical sensing device according to the embodiment in FIG. 5(A), FIG. 5(C) is the schematic view showing the assembly of the components shown in FIG. 5(A), and FIG. 5(D) is the back view showing the assembly of the components shown in FIG. 5(A). As shown in FIGS. 5(A)-5(B), the electrochemical sensing device 2 includes the testing body 21, the electrochemical sensing strip 23, the testing holder 24, the display 213 and the control key 214. The testing body 21 includes the connecting slot 211. The testing holder 24 is detachably connected to the connecting slot 211 and includes the signal contacts 241 and the transmitting component 242. The electrochemical sensing strip 23 includes the electrodes 2341 and 2342 (FIG. 5(B)), the opening 2321 and the ventilator 2352, and is detachably connected to the testing holder 24. The electrodes 2341 and 2342 would be connected to the signal contacts 241 when the electrochemical sensing strip 23 is connected to the testing holder 24. The transmitting component 242 is applied to transmit the signals received by the signal contacts 241 to the testing body 21.

Since the reactions between the electrochemical sensing strips within different batches and the target analyte are not exactly identical, a storage component (not shown) containing the correction information for the individual batches of electrochemical sensing strips is able to be installed into the testing holder 24 for providing the testing body 21 the relevant correction information, if necessary. On the contrary, it is also possible to buy the electrochemical sensing strips meeting the relevant built-in correction limitations of the testing body for convenience. However, since the testing holder 24 of the present invention is a detachable testing holder, it is possible to exchange the testing holder 24 when it is contaminated.

In view of the aforesaid, the present invention provides a novel electrochemical sensing device having the detachable component composed of the storage element and the testing holder. The detachable component is able to be replaced when the relevant electrochemical sensing strips are exhausted. In addition, since the structure of the electrochemical sensing device of the present invention is more compact and the occurrences of the relevant contaminations are reduced, the relevant cost is saved and the safeties of the users are improved. Therefore, the present invention is extremely suitable for being used in the industrial production.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. An electrochemical sensing device, comprising:
a main body having a connecting slot;
a testing holder having a detachable connection to said connecting slot; and
an electrochemical sensing strip detachably combined with said testing holder for analyzing a sample.

2. The electrochemical sensing device according to claim 1, wherein said main body further comprises a display and a control key.

3. The electrochemical sensing device according to claim 1, wherein said testing holder is a disposable testing holder.

4. The electrochemical sensing device according to claim 1, wherein said testing holder further comprises a storage component for storing a correction information.

5. The electrochemical sensing device according to claim 4, wherein said connecting slot further comprises a plurality of signal contacts.

6. The electrochemical sensing device according to claim 5, wherein said correction information is transmitted to said main body via said plurality of signal contacts when said testing holder is combined with said connecting slot.

7. The electrochemical sensing device according to claim 4, wherein said electrochemical sensing strip comprises at least an insulating substrate having a reaction concavity and an opening located thereon, an electrochemical reaction layer located in said reaction concavity, and an electrode device located in said reaction concavity for transmitting a signal resulting from an electrochemical reaction performed in said electrochemical reaction layer.

8. The electrochemical sensing device according to claim 7, wherein said reaction concavity comprises at least a hole.

9. The electrochemical sensing device according to claim 8, wherein said electrode device passes through said hole.

10. The electrochemical sensing device according to claim 7, wherein said electrode device comprises plural electrodes selected from a group consisting of a counter electrode, a working electrode, a reference electrode and a detecting electrode.

11. The electrochemical sensing device according to claim 10, wherein said plural electrodes are connected to said signal contacts for transmitting said signal when said testing holder is combined with said connecting slot and said electrochemical sensing strip is combined with said testing holder.

12. The electrochemical sensing device according to claim 10, wherein each of said plural electrodes comprises a metal and a thin film.

13. The electrochemical sensing device according to claim 12, wherein said metal is one selected from a group consisting of a copper, a titanium, a nickel, a gold, a platinum, a rhodium, a palladium, a ruthenium, a silver, a chromium, an iron, an aluminum, an iridium and an alloy thereof.

14. The electrochemical sensing device according to claim 12, wherein said thin film is made of a material selected from a group consisting of a copper, a titanium, a nickel, a gold, a platinum, a rhodium, a palladium, a ruthenium, a silver, a chromium, an iron, an aluminum, an iridium and an alloy thereof.

15. The electrochemical sensing device according to claim 10, wherein each of said plural electrodes comprises a carbon body and a thin film.

16. The electrochemical sensing device according to claim 7, wherein said electrochemical reaction layer further comprises a chemical agent for reacting with an analyte of said sample to generate said signal.

17. The electrochemical sensing device according to claim 16, wherein said sample is added into said reaction concavity via said opening.

18. An electrochemical sensor, comprising:
a main body having a detachable testing device; and
an electrochemical sensing strip detachably combined with said detachable testing holder for analyzing a sample.

19. The electrochemical sensor according to claim 18, wherein said detachable testing device comprises a base having plural signal contacts and a disposable testing holder.

20. The electrochemical sensor according to claim 19, wherein said detachable testing device is connected to a storage component storing a correction information.

21. The electrochemical sensor according to claim 20, wherein said correction information is transmitted to said main body via said plural signal contacts when said detachable testing device is combined with said main body.

22. The electrochemical sensor according to claim 20, wherein said electrochemical sensing strip comprises at least an insulating substrate having a reaction concavity and an opening located thereon, an electrochemical reaction layer located in said reaction concavity, and an electrode device located in said reaction concavity for transmitting a signal resulting from an electrochemical reaction performed in said electrochemical reaction layer.

23. The electrochemical sensor according to claim 22, wherein said reaction concavity comprises at least a hole.

24. The electrochemical sensor according to claim 23, wherein said electrode device passes through said hole.

25. The electrochemical sensor according to claim 22, wherein said electrode device comprises plural electrodes selected from a group consisting of a counter electrode, a working electrode, a reference electrode and a detecting electrode.

26. The electrochemical sensor according to claim 25, wherein said plural electrodes are connected to said signal contacts for transmitting said signal when said detachable testing device is combined with said connecting slot and said electrochemical sensing strip is combined with said main body.

27. The electrochemical sensor according to claim 25, wherein each of said plural electrodes comprises a metal and a thin film.

28. The electrochemical sensor according to claim 27, wherein said thin film is made of a material selected from a group consisting of a copper, a titanium, a nickel, a gold, a platinum, a rhodium, a palladium, a ruthenium, a silver, a chromium, an iron, an aluminum, an iridium and an alloy thereof.

29. The electrochemical sensor according to claim 25, wherein each of said plural electrodes comprises a carbon body and a thin film.

30. The electrochemical sensor according to claim 22, wherein said electrochemical reaction layer further comprises a chemical agent for reacting with an analyte of said sample to generate said signal.

31. The electrochemical sensor according to claim 30, wherein said sample is added into said reaction concavity via said opening.

32. A portable electrochemical sensing device, comprising: a main body having a connecting slot; and
a testing holder having a detachable connection to said connecting slot.
